(19) United States
(12) Patent Application Publication
(10) Pub. No.: US 2004/0072994 A1
(43) Pub. Date: Apr. 15, 2004

(54) Nanostructures including controllably positioned and aligned synthetic nanotubes, and related methods

(76) Inventors: Daniel J.C. Herr, Chapel Hill, NC (US); Jean M.J. Frechet, Oakland, CA (US)

Correspondence Address: MYERS BIGEL SIBLEY & SAJOVEC, PO BOX 37428, RALEIGH, NC, 27627, US

(21) Appl. No.: 10/271,104

(22) Filed: Oct. 15, 2002

(51) Int. Cl. B32B 9/00; D01C 5/00

(52) U.S. Cl. 530/350; 428/408; 423/447.3

(57) ABSTRACT

An integrated nanostructure comprises a microelectronic substrate having a surface; a catalyst disposed upon the surface of the microelectronic substrate and positioned thereupon within a first predetermined set of X and Y coordinates, wherein the catalyst is activated within a second predetermined set of X and Y coordinates defined within the surface of the microelectronic substrate; and a nanotube selectively disposed upon the activated second predetermined set of X and Y coordinates defined within the surface of the microelectronic substrate, such that the nanotube is controllably grown at a predetermined position upon the surface of the microelectronic substrate; wherein at least one selected from the group consisting of: (1) the disposition according to the first predetermined set of X and Y coordinates and (2) the activation of the catalyst according to the second predetermined set of X and Y coordinates is scaled with atomic precision.

### FIELD OF THE INVENTION

The present invention relates to nanostructures and related methods of fabricating same, and more particularly to nanometer scale structures including controllably positioned and controllably aligned synthetic nanotubes.

### BACKGROUND OF THE INVENTION

Nanotubes are known in the art as elongated tubular bodies which are typically only a few atoms in circumference. Typically, the nanotubes are hollow and have a linear fullerene structure. Advantageously, the length of the nanotubes potentially may be millions of times greater than the molecularsized diameter. Nanotubes are currently being proposed for a number of applications since they possess a very desirable and unique combination of physical properties relating to, for example, strength and weight. Additionally, the nanotubes have also demonstrated unique electrical properties in that they may be fabricated in such a manner so as to be metallic or semiconducting. Because of the above properties, it is proposed-that nanotubes may be used in a number of applications relating to tips for use in scanning probe microscopy (SCM), in nanoscale probes, to manipulate or image nanosystems (e.g., biomolecular systems), nanoelectromechanical systems (e.g., sensors, actuators, and other mechanical components. As an example, Meyyappan, M. and Han, J., Buckytubes in a Nanoworld, Prototyping Technology International, Issue 6, pp. 14-19 (1998) propose various conventional methods for producing nanotubes, one of which involves a process in which nanotubes are formed, transported by a heated inert gas, and deposited in a cooler location.

Several references propose methods for forming nanotubes. Tully et al. Dendrimer-Based Self-Assembled Monolayers as Resists for Scanning Probe Lithography, Advanced Materials, Vol. 11, No. 4 (1999) pp. 314-319 propose nanotubes that are present in arrays for patterning dendrimer films on silicon substrates.

Dai, H., Franklin, N., and Han J., Exploiting the Properties of Carbon Nanotubes for Nanolithography, Applied Physics Letters, 73 (11), pp 1508-1510 (1998) propose forming carbon nanotubes into atomic force microscopy and scanning tunneling microscopy tips. The nanotubes are allegedly made from both as-grown and oxidation-purified multi-walled nanotube materials synthesized by arc-discharge. Dai et al. further proposes that the nanotubes may be cleaved to yield nanotube tips with dome closed ends.

Dai et al., Nanotubes as Nanoprobes in Scanning Probe Microscopy, Nature, Vol. 384 (1996) pp. 147-150 proposes the formation of a single nanotube attached to the pyramidal tip of a silicon cantilever for scanning force microscopy (SFM).

Kong, J., Soh, H T., Cassell A M., Quate, C F., Dai, H J, Synthesis of Individual Single-Walled Carbon Nanotubes On Patterned Silicon Wafers, Nature, 395 (6705), pp. 878-881 (1998) propose methods for forming single-walled carbon nanotubes on silicon wafers patterned with metallic islands. In particular, the method involves first patterning iron (III) nitrate islands on the silicon substrates by employing a methane solution containing the metallic material. Chemical vapor deposition (CVD) is employed in the deposition of the methane. Nanotubes are synthesized and have roots in the iron (III) nitrate islands.

Of the above references, Dai et al. Exploiting the Properties of Carbon Nanotubes for Nanolithography, supra propose the formation of nanostructures within a defined X-Y area having micron-scale dimensions. Tully et al. supra propose patterning dendrimer monolayers as resists having defined nanoscale dimensions. Tully et al. also propose using nanotips to selectively expose a surface underneath the dendrimer monolayer. Malenfant et al. Well-Defined Triblock Hybrid Dendrimers Based on Lengthy Oligothiophene Cores and Poly(benzyl ether) Dendrons, J. Am. Chem. Soc. Vol. 120, (1998) pp. 10990-10991 propose the synthesis of oligothiophenes that may be attached to the focal point of convergent poly(benzyl ether) dendrimers. The end functionalization of the oligomer is reported to allow for their incorporation into nanometer-size dendritic moieties.

Additionally, a number of references teach other methods for producing nanotubes. For example, U.S. Pat. No. 6,129,901 to Moskovits et al. proposes a method for producing nanotubes via catalyst pyrolysis. More specifically, Moskovits et al. proposes anodizing an aluminum substrate in an effective bath to produce an alumina template with a plurality of pores each having a pore diameter. An effective catalyst is thereafter deposited into the pores and the alumina template is exposed to an effective hydrocarbon gas to grow nanotubes in the pores.

U.S. Pat. No. 6,146,227 to Mancevski proposes a method for manufacturing carbon nanotubes as functional elements of MEMS devices. The method includes, preparing a MEMS substrate suitable for growth of a carbon nanotube. A nanosize hole or nanoscale catalyst retaining structure, (NCRS) is then fabricated in a layer on the MEMS substrate in which a nanotube growth catalyst is deposited. The catalyst may be deposited by electrochemical deposition, chemical deposition, electrooxidation, electroplating, sputtering, thermal diffusion and evaporation, physical vapor deposition, sol-gel deposition, and chemical vapor deposition. Thereafter, a nanotube is grown within the nanosize hole.

PCT Publication No. WO 00/09443 proposes making several nanotubes using catalyst islands disposed on a substrate or on the free end of an atomic force microscope cantilever. In particular, the reference proposes disposing a layer of resist on the top surface of a substrate and patterning the same. A solution of Fe(NO₃)₃ in methanol, mixed with alumina nanoparticles, is deposited on the surface of the resist and substrate. The substrate is subsequently heated, decomposing Fe(NO₃)₃ to Fe₂O₃. The Fe₂O₃/nanoparticle mixture is taught to be an active catalyst which will catalyze the formation of carbon nanotubes when exposed to methane gas at elevated temperatures.

In general, the above references teach making nanotubes using bulk techniques. More particularly, such bulk techniques typically involve placing a relatively non-discreet amount of catalyst material on a substrate and thereafter growing one or more nanotubes. Nonetheless, such methods are disadvantageous in that the nanotubes are synthesized in a relatively random and indiscriminate fashion. Accordingly, it is extremely difficult if not impossible to control the physical and/or electrical properties of such nanotubes.

Thus, there is a need in the art to provide nanotubes which have been grown in a more controlled fashion relative to processes taught in the prior art such that the nanotube has pre-designed, specific electrical and/or mechanical properties.

### SUMMARY OF THE INVENTION

In one aspect, the invention provides an integrated nanostructure. The integrated nanostructure comprises a microelectronic substrate having a surface, a catalyst disposed upon the surface of the microelectronic substrate and positioned thereupon within a first predetermined set of X and Y coordinates, wherein the catalyst is activated within a second predetermined set of X and Y coordinates defined within the surface of the microelectronic substrate; and a nanotube selectively disposed upon the activated second predetermined set of X and Y coordinates defined within the surface of the microelectronic substrate, such that the nanotube is controllably grown at a predetermined position upon the surface of said microelectronic substrate. At least one selected from the group consisting of: (1) the disposition according to the first predetermined set of X and Y coordinates and (2) the activation of the catalyst according to the second predetermined set of X and Y coordinates is scaled with atomic precision.

In another aspect, the invention provides an integrated nanostructure array. The array comprises a microelectronic substrate having a surface and a plurality of nanostructures. Each nanostructure within the plurality is disposed in a predetermined positional relationship with respect to the remaining nanostructures within the plurality. Each nanostructure comprises a microelectronic substrate having a surface, a catalyst disposed upon the surface of the microelectronic substrate and positioned thereupon within a first predetermined set of X and Y coordinates, wherein the catalyst is activated within a second predetermined set of X and Y coordinates defined within the surface of the microelectronic substrate; and a nanotube selectively disposed upon the activated second predetermined set of X and Y coordinates defined within the surface of the microelectronic substrate, such that the nanotube is controllably grown at a predetermined position upon the surface of the microelectronic substrate. At least one selected from the group consisting of: (1) the disposition according to the first predetermined set of X and Y coordinates and (2) the activation of the catalyst according to the second predetermined set of X and Y coordinates is scaled with atomic precision.

In another aspect, the invention provides a method of selectively forming a nanotube at a predetermined position upon a microelectronic substrate. The method comprises the steps of depositing a catalyst bearing moiety upon said microelectronic substrate within a first predetermined set of X and Y coordinates defined within the surface the substrate; activating the catalyst bearing moiety at a second predetermined set of X and Y coordinates defined within the surface of the microelectronic substrate; and growing a single nanotube at the second predetermined set of X and Y coordinates along an axis having a predetermined relationship with respect to a plane defined by the microelectronic substrate. In the method of the invention, at least one of the steps selected from the group consisting of: (1) depositing a catalyst upon the microelectronic substrate and (2) activating the catalyst is carried out with atomic scale precision.

These and other aspects and advantages are encompassed by the present invention.

### BRIEF DESCRIPTION OF THE DRAWINGS

FIGS. 1A and 1B depict embodiments of nanostructures defined according to the invention;

FIGS. 2A and 2B depict embodiments of nanostructure arrays defined according to the invention;

FIGS. 3A through 3C depict embodiments of a method of making a nanostructure according to the invention; and

FIGS. 4A through 4C depict embodiments of a method of making a nanostructure according to the invention.

FIG. 5 ilustrates the assembly of a dendrimer by attachment of three branched building blocks to a trifunctional core.

FIG. 6 illustrates an example of a synthetic route for a dendrimer.

### DETAILED DESCRIPTION OF THE PREFERRED EMBODIMENTS

The invention will now be described with respect to the preferred embodiments set forth herein in the detailed specification and the drawings. It should be appreciated that these embodiments are for the purposes of illustrating the invention and are not meant to limit the scope of the invention as defined by the claims.

In one aspect, the invention provides an integrated nanostructure. The integrated nanostructure comprises a microelectronic substrate having a surface, a catalyst disposed upon the surface of the microelectronic substrate and positioned thereupon within a first predetermined set of X and Y coordinates, wherein the catalyst is activated within a second predetermined set of X and Y coordinates defined within the surface of the microelectronic substrate; and a nanotube selectively disposed upon the activated second predetermined set of X and Y coordinates defined within the surface of the microelectronic substrate, such that the nanotube is controllably grown at a predetermined position upon the surface of the microelectronic substrate. At least one selected from the group consisting of the (1) disposition according to the first predetermined set of X and Y coordinates and the (2) activation of the catalyst according to the second predetermined set of X and Y coordinates is scaled with atomic precision.

In another aspect, the invention provides an integrated nanostructure array. The integrated nanostructure array comprises a microelectronic substrate having a surface and a plurality of nanostructures. Each nanostructure within the plurality is disposed in a predetermined positional relationship with respect to the remaining nanostructures within the plurality. Each nanostructure comprises a microelectronic substrate having a surface; a catalyst disposed upon the surface of the microelectronic substrate and positioned thereupon within a first predetermined set of X and Y coordinates, wherein the catalyst is activated within a second predetermined set of X and Y coordinates defined within the surface of said microelectronic substrate; and a nanotube selectively disposed upon the activated second predetermined set of X and Y coordinates defined within the surface of said microelectronic substrate, such that the nanotube is controllably grown at a predetermined position upon the surface of said microelectronic substrate. At least one selected from the group consisting of: (1) the disposition according to the first predetermined set of X and Y coordinates and (2) the activation of the catalyst according to the second predetermined set of X and Y coordinates is scaled with atomic precision.

In another aspect, the invention provides a method of selectively forming a nanotube at a predetermined position upon a microelectronic substrate. The method comprises the steps of depositing a catalyst bearing moiety upon said microelectronic substrate within a first predetermined set of X and Y coordinates defined within the surface of the substrate; activating the catalyst bearing moiety at a second predetermined set of X and Y coordinates defined within the surface of said microelectronic substrate; and growing a single nanotube at the second predetermined set of X and Y coordinates along an axis having a predetermined relationship with respect to a plane defined by the microelectronic substrate. At least one of said steps selected from the group consisting of: (1) depositing a catalyst upon the microelectronic substrate and (2) activating the catalyst is carried out with atomic scale precision.

For the purposes of the invention, the term “atomic scale precision” refers to either or both of the deposition and activation of the catalyst being carried out in the sub-nanometer range. In one preferred embodiment, the atomic scale precision is no greater than about 5 angstroms (Å). In another preferred embodiment, the deposition and/or activation of the catalyst is on the scale ranging from about 1, 5, or 10 angstroms (Å) to about 10, 25, or 50 angstroms (Å).

As set forth hereinabove, the catalyst is disposed upon the surface of the microelectronic substrate within a first predetermined set of X and Y coordinates. The activation of the catalyst occurs within a second predetermined set of X and Y coordinates, which may be the same or different than the first set of X and Y coordinates. In a preferred embodiment, at least one of the first and second predetermined sets of X and Y coordinates has atomic scale dimensions as defined by, but not constrained to, those set forth above. As further described in detail herein, the disposition and/or activation may be carried out using a variety of techniques. For example, in one embodiment, the disposition and/or activation is carried out through integrated circuit vapor deposition processing.

Various microelectronic substrates can be used in accordance with the invention, the selection of which are known to the skilled artisan such as, for example, semiconductor substrates. The substrates can be formed from a number of materials. Examples of such materials include, without limitation, silicon, silicon dioxide, silicon nitride, silicon-carbide, glasses, gallium arsenide, gallium antimonide, indium arsenide, indium antimonide, germanium, aluminum and various other elemental and compound semiconductors. The surface of the microelectronic substrate can be either substantially planar in topography or substantially non-planar in topography. In one embodiment, the integrated nanostructure may comprise a plurality of distinct substrates and at least one of the plurality of distinct substrates has the nanotube disposed thereon. In a preferred embodiment, at least two of the plurality of distinct substrates have the nanotube disposed at a predetermined position thereupon. Combinations of the above embodiments can also be employed for the purposes of the invention.

In a preferred embodiment, the surface of the microelectronic substrate is of uniform integrity. For the purposes of the invention, the term “uniform integrity” refers to the surface be continuous in such a manner so as to be substantially free from discontinuities, e.g., holes, perforations, and the like, that may be present in the substrate surface. Accordingly, in these embodiments, the invention is distinguished from other prior art techniques for growing nanotubes in which the surface of a substrate contains a discontinuity formed therein to assist in the growing of such nanotubes.

Nanotubes represent a general class of single-walled or multi-walled tubular structures. As those skilled in the art can appreciate, nanotubes can be created from a variety of materials, such as carbon, boron, nitrides, combinations thereof, and the like. The composition of a nanotube may be homogenous and mostly comprised of single elements, such as carbon or boron for example. Alternatively, the composition of a nanotube may be heterogeneous with varying stoichiometries of more than one component element. Examples include boron nitride, tungsten disulphide, molybdenum disulphide, and SiO^{x}[x<2] or SiO^{x}-carbon composite nanotubes. The elemental composition and the helicity of a nanotube will be factors in determining their macroscopic qualities. For example, boron nitride nanotubes behave as electrical insulators exhibiting a band gap of approximately five volts. For instance, a carbon nanotube may exhibit metallic conductivity or semiconducting conductivity, depending on its helicity and whether it is single-walled or multi-walled.

A wide variety of catalyst bearing moieties can be used for the purposes of the invention, the selection of which are known to one skilled in the art. For the purposes of the invention, the term “catalyst bearing moiety” is defined as a substance or sample that contains the catalyst, i.e., the catalyst may be attached, carried, or bonded by the moiety. For example, in one embodiments a catalyst bearing moiety may serve as a carrier molecule by covalently binding a set of catalyst atoms into a configuration of catalyst atoms. In other embodiments, the arrangement of catalyst atoms in space may be held in place in a more relative softer fashion by forces believed to be associated with, but not limited to, hydrogen bonding, coordination complexes, stable surface regions, etc. Other moieties may include the class of metal cluster compounds, such as organometallic molecules or coordinated complexes with catalyst atoms at specific, well defined, molecular locations, for instance. For purposes of the present invention, moieties could be rigid with respect to the mobility of the catalyst metal atom or atoms. For example, organometallic molecule clusters could include ferrocene Fe(C5H5)2, metallocarboranes such as C2B3H5Fe(CO)3, or nickel based coordinated complexes such as decamethylnickelocene Ni(C5Me5)2 for instance. Of course, the organometallic molecules or coordinated complexes could include multiple metal atoms such as Fe4C(CO)13, or multiple types of metal atoms such as specific iron-nickel complexes.

The catalyst atoms may be fabricated using various techniques known to those skilled in the art. Exemplary techniques include, without limitation, lithography, maskless patterning, imprint (e.g., step-and-flash patterning or self-assembly), thin film or interface deposition, Chemical Vapor Deposition, molecular beam epitaxy (MBE) or atomic layer epitaxy (ALE). The positional assembly of individual or multiple catalyst atoms can be achieved, in one embodiment, by proximity probe manipulation of individual atoms at relatively low temperatures. The fixing of the atoms and the suppression of their movement can be achieved by a variety of techniques. Exemplary techniques include, without limitation, topography or surface driven segregation of atoms and/or surface passivation, An embodiment which encompasses placing atoms at predetermined locations is set forth in U.S. Pat. No. 5,981,316 to Yamada et al., the disclosure of which is incorporated herein by reference in its entirety.

A wide ranging number of catalyst bearing moieties may be employed for the purposes of the invention, the selection of which is known by one skilled in the art. Although not intending to be bound be theory, it is believed that these moieties provide the architectural support for the desired arrangement of catalyst atoms in space to be transferred to the substrate. Examples of catalyst bearing moieties that can be employed include, without limitation, inorganic materials, organometallic materials, organic materials, such as dendrimers, biomolecules, and combinations thereof. In one embodiment, as an example, the catalyst bearing moiety is at least one biomolecule selected from the group consisting of RNA, DNA, proteins, and combinations thereof.

Preferably, the catalyst bearing moieties comprises at least one dendrimer. For the purposes of the invention, the term “dendrimer” is defined as one or more highly branched, fractal-like macromolecules of three-dimension size, shape and topology. In various embodiments, the dendrimers can be prepared with very narrow molecular weight distribution. In contrast to conventional long chain linear polymers, dendritic molecules typically have well-defined three dimensional sizes and shapes. They also tend to possess a large number of untangled chain-ends and surface functional groups with an identical or similar micro-environment. Due to their structural homogeneity and regularity, it is believed that the structural-property relationship of dendritic molecules can be rationalized in a more precise manner. In various embodiments, dendrimers can also mimic certain properties of micelles and even those of biomolecules. Numerous applications of these compounds are conceivable, particularly mimicking the functions of large biomolecules such as protein, enzymes and immunogens. This new branch of “supramolecular chemistry” should spark new and more exciting developments in both bioorganic and macromolecular chemistry.

The dendrimers may include a number of compounds such as, without limitation, poly(benzyether)dendrimers such as those, for example, disclosed in D. C. Tully et al., Advanced Materials, 11, No. 4, pp. 314-319 (1999) as well as oligothiophenes described in P. R. L. Malenfant et al., J. Am. Chem. Soc., 1998, 120 pp. 10990-10991.

The dendrimers may be placed on the substrate in accordance using known and accepted techniques such as, for example, Atomic Force Microscopy (AFM) or Scanning Tunneling Microscopy (STM). The dendrimers can be positioned on the microelectronic substrate in a variety of manners. In another embodiment, the surface of the microelectronic substrate can be coated with a dendrimer(s) such that one or more layers of dendrimers covers the substrate surface. In a preferred embodiment, such a layer is in the form of a monolayer. The monolayer preferably has a thickness ranging from about 1 or 5 nm to about 10, 15, or 20 nm. In a preferred embodiment, the lateral and vertical dimensions are similar or the same for the monolayer. The dendrimer(s) may be manipulated according to known techniques to possess any number of properties. For example, the catalyst bearing moieties comprising the dendrimers may possess resist-like properties.

Preferably, the dendrimer may be of various dimensions. In one preferred embodiment, for example, the dendrimer has a diameter of at least one nanometer.

Preferably, the catalyst is disposed on the surface of the substrate by the catalyst bearing moiety. Materials that may be employed as catalysts are numerous. Non-limiting examples of catalysts include, but are not limited to iron or nickel. The catalyst may be of various sizes. In one embodiment, for example, the catalyst may be one atom. The amount of catalyst that may be employed can vary according to design considerations. Although not intended to be bound by theory, it is believed that the amount of catalyst has a functional relationship to the diameter of the resulting nanotube. Thus, various catalyst sizes can be used. In various embodiments, the catalyst diameter can range from one atom (i.e., about 4 Å), to about 50 atoms). In general, the catalyst diameter can range from about 1 nm to about 20 nm, although it should be appreciated that other sizes can be employed.

The activation of the catalyst bearing moiety may be achieved by using methods accepted in the art. For the purposes of the invention, the term “activation” is defined as a process by which the catalyst occupies the desired configuration of catalyst atoms in space and the catalyst entity is located at the desired location on the substrate, such that the growth yields the desired nanotube.

Exemplary techniques for activating the catalyst bearing moiety include, without limitation, manipulating the catalyst bearing moiety, inducing a change in the catalyst bearing moiety, or patterning the catalyst bearing moiety through AFM or STM. The term “manipulating” the catalyst bearing moiety may be defined as moving the moiety to a desired location on a substrate.

In one embodiment, an example of “inducing a change” in the catalyst bearing moiety may be the release of the catalyst onto the substrate, such that the catalyst atoms retain the configuration required to effect the desired nanotube growth.

The area or size of the catalyst bearing moiety on the microelectronic substrate can be selected by one skilled in the art, and can vary based on a number of factors. For example, such an area or size may depend on the size of the catalyst bearing moiety (e.g., dendrimer) along with the distribution of catalyst functionality within the catalyst bearing moiety. In one embodiment, it may be desirable to optimize the spot size of the catalyst bearing moiety to accommodate the growth of a predetermined number of nanotubes needed to grow from the spot of the catalyst bearing moiety. As an example, a dendrimer having a diameter ranging from three to eight nanometers is expected to provide enough exposed catalyst to be capable of facilitating the growth of roughly one or more nanotubes, depending on the particular application. In general, the number of nanotubes should grow according to spot size and concentration of catalyst bearing moiety. In one embodiment, clusters of nanotubes may be grown using a suitable process (e.g., chemical vapor deposition) on an catalyst bearing moiety having a diameter ranging from about 10 μm to about 100 μm.

Subsequent to deposition, the catalyst bearing moiety may be removed from the substrate using various techniques, such as, but not limited to field induced chemistry, photolysis, thermal degradation, and the like.

Various nanotubes can be grown on the catalyst bearing moieties. For the purposes of the invention, a “nanotube” is defined conventionally, and is a tubular, strand-like structure which has a circumference on the atomic scale. In one embodiment, a typical diameter (or width) of a nanotube ranges from about 0.4, 1, 3, or 5 nm to about 5, 7, or 10 nm. The diameter may be potentially longer for multi-walled nanotubes. A preferred nanotube has a length of up to about 10 μm. Such a length however may differ from this range depending on the particular application. Preferably, the nanotube has a helicity defined according to at least one selected from the group consisting of the first predetermined set of X and Y coordinates and the second predetermined set of X and Y coordinates. Accordingly, it is believed that the physical and/or electrical properties of the nanotube may be influenced according to the helicity. In a preferred embodiment, the nanotube is defined along an axis that intersects the surface of the microelectronic substrate. As an example, the nanotube may be defined along an axis having a predetermined positional alignment with respect to the surface of the microelectronic substrate. The nanotube may be formed from various materials such as, for example, carbon, boron nitride, composites thereof, and other materials and combinations the selection of which will be within the skill of one in the art. The nanotube typically is formed from carbon. In such an embodiment, the nanotube is formed as a fullerene molecule containing a hexagonal lattice structure. The nanotube may be present as a single-walled nanotube or a multi-walled nanotube.

The nanotube may be formed such that it displays a variety of physical and/or electrical properties. For example, the nanotube may be fabricated such that it has a metallic, electrical conductivity (e.g., from about 3.3×10⁴ (Ω×cm)⁻¹ to about 2×10⁵ (Ω×cm)⁻¹), a semiconducting electrical conductivity (e.g., from about 5.0×10¹ (Ω×cm)⁻¹ to about 1.25×10³ (Ω×cm)⁻¹), or an approximately insulating electrical conductivity (e.g., for boron nitride nanotubes having an electrical conductivity from about 102(Ω×cm)⁻¹ for voltages of 10 volts or less to about 10−1. (Ω×cm)⁻) for voltages between 20 v and 80 v. These estimated resistivity values are somewhat lower than one would expect for a true insulator, and fall somewhat between the semiconductor and conductor ranges. Advantageously, the nanotubes can be possess certain physical properties such that they are capable of functioning in various applications. For example, the nanotube may comprise a tip member. The tip member may be selected from a number of possible choices such as, for example, a probe tip member (e.g., for metrology applications), a patterning tip member, and a repair tip member. Other examples for uses of the nanotube include, without limitation, advanced interconnects, dielectrics, and semiconductors, advanced discrete and integrated devices, three dimensional engineered networks, architectures, and composites having nanometer or molecular scale control, bridges or interfaces with biological and neurological systems, biomimetic and biocompatible structures, assays, material storage and delivery, and filters and waveguides. Exemplary applications for the nanotubes include, without limitation, an electrical interconnect member having a predetermined electrical conductivity, a mechanical stress relief member, or a thermal stress relief member. In one embodiment, for example, a brush-like array of nanotubes may be employed to electrically connect a chip to a package. These nanotubes have the potential to exhibit some flexibility and could possibly serve to relieve the stress of this chip to package connection.

Examples of nanotube synthesis techniques include, without limitation, catalyzed Chemical Vapor Deposition (CVD) growth or the deposition of nanotubes. Resist technologies include, without limitation, energy, beam, photon, and/or pressure sensitive materials and processes which induce changes in chemistry or structure. Patterning methods include, without limitation, AFM/STM lithography, imprint related patterning, and the like.

The nanotubes and and integrated nanostructure arrays of the present invention may be made according to various techniques. In one aspect, one or more individual atoms that are eventually used in forming one or more nanotubes on a substrate described herein may be placed and positioned on the substrate by a number of methods. For example, in one embodiment, a scanning tunneling microscope (STM) may be used to place and/or position one or more individual atoms on the substrate surface. Exemplary techniques are described in Stroscio, J. A. et al., “Atomic and Molecular Manipulation with the Scanning Tunneling Microscope”, Science, New Series, Vol. 254, Issue 5036 (Nov. 29, 1991) pp. 1319-1326 and Eigler, D. M. et al., “Positioning Single Atoms With a Scanning Tunneling Mciroscope”, Nature, Vol. 344, (Apr. 5, 1990), pp. 524-526. Various techniques involving STM can be used such as, without limitation, parallel processes (e.g., field-assisted diffusion and sliding processes), perpendicular processes, (e.g., transfer-on or near-contact processes, filed evaporation, and electromigration processes). Thereafter, the atom or atoms may be activated so as to form one or more nanotubes therefrom by employing any of the synthesis techniques described herein.

The invention will now be described in greater detail in reference to the drawings. It should be emphasized that the drawings are merely set forth to illustrate the invention, and do not limit the scope of the invention as defined by the claims.

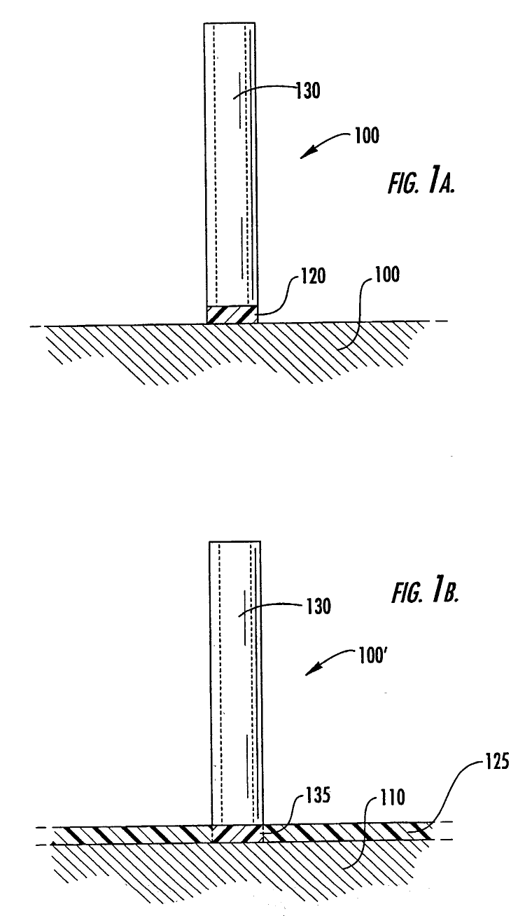

FIGS. 1A and 1B illustrate different embodiments of nanostructures referred to respectively as 100 and 100″. Referring specifically to FIG. 1A, the nanostructure 100 comprises a microelectronic substrate 110 having a surface 115. The surface may be either substantially planar or non-planar in topography. Catalyst bearing moiety 120 is disposed upon the surface of the microelectronic substrate and is controllably positioned thereon. Positioned on the activated predetermined set of X and Y coordinates is nanotube 130. As shown, the nanotube has a width wₙ which is equal or substantially equal to the width w_{c} of the catalyst bearing moiety 120. In this embodiment, the nanotube 130 is defined along an axis z which intersects the surface 115 of the microelectronic substrate 110. It should be appreciated however, that the nanotube may be defined along other axes. In this embodiment, the z-axis has a predetermined positional alignment with respect to the surface 115 of microelectronic substrate 110.

Referring now to FIG. 1B, a nanostructure 100′ is depicted having nanotube 130 present on an activated portion 135 of catalyst bearing moiety 125 in a similar fashion to FIG. 1A. The catalyst bearing moiety 125 may be deposited and activated on the surface 115 of microelectronic substrate 110 by employing, without limitation, techniques set forth herein. Similar to FIG. 1A, the width wₙ of the nanotube 130 is equal or substantially equal to the width w_{c} of the activated portion 135 of the catalyst bearing moiety 125.

Although not illustrated, the microelectronic substrate 110 may comprise a plurality of distinct substrates such that at least one of the substrates has a nanotube 130 disposed thereon. In a specific embodiment, for example, at least two of the plurality of distinct substrates may have nanotubes disposed thereon.

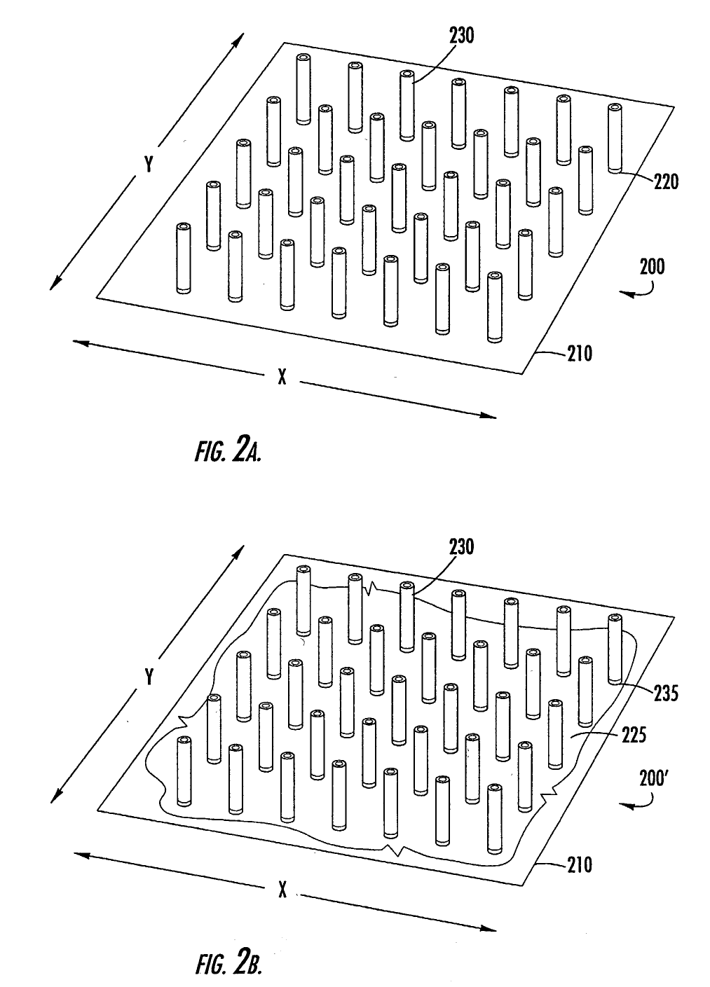

FIG. 2A illustrates an integrated nanostructure array denoted by 200. The array comprises a microelectronic substrate 210 having a surface 215. Similar to the embodiments shown in FIGS. 1A and 1B, the surface 215 of the substrate 210 may be either substantially planar in topography or substantially non-planar in topography. A plurality of nanostructures 230 are present on microelectronic substrate 210. As shown, each nanostructure is disposed in a predetermined relationship with respect to the remaining nanostructures within the plurality. In one embodiment, for example, the nanostructures 230 may be positioned at equal distances from each other, although other embodiments are contemplated for the purposes of the invention. Each nanostructure comprises a catalyst 220 disposed on the surface 215 of the microelectronic substrate 210 and a nanotube 230 disposed upon the catalyst 220.

In FIG. 2A, each of the catalyst bearing moieties 220 is controllably positioned on the surface 215 of the microelectronic substrate 210 and is activated within a predetermined set of X and Y coordinates defined within the surface 215 of the microelectronic substrate 210. Similar to the embodiments depicted in FIGS. 1A and 1B, the width of each catalyst bearing moiety is approximately equal to the width of the corresponding nanotube present thereon. In this embodiment, the catalyst bearing moiety is deposited on the surface 215 of the microelectronic substrate 210 within a first predetermined subset of X and Y coordinates with nanometer scale positional precision. Additionally, and as illustrated in FIG. 2A, each catalyst bearing moiety within the plurality selectively applies catalyst to a predefined area defined by the predetermined subset of X and Y coordinated present upon the surface 215 of the microelectronic substrate 210. The catalyst bearing moieties 220 may be formed and activated according to methods set forth herein, as well as others.

As shown in FIG. 2A, each nanotube 230 is present on a corresponding catalyst bearing moiety 220. The widths of each nanotube 230 and catalyst bearing moiety 220 are equal or substantially equal to each other. In this embodiment, the average distance between two adjacent nanotubes along the Y-axis is y₁ (e.g., less than about 0.5 nm) and the average distance between two adjacent nanotubes along the X-axis is x₁ (e.g., less than about 0.5 nm). It should be appreciated that other distances between nanotubes may be employed as desired by a person skilled in the art. These distances may be same or different, according to the intentions of the skilled artisan. As shown, each of the nanotubes 230 within the plurality is defined along an axis (in this embodiment, the z-axis) having a predetermined positional alignment with respect to the surface 215 of the microelectronic substrate 210. In FIG. 2A, the z-axis is positioned perpendicular or substantially perpendicular to the plane of the microelectronic substrate 210. It should be appreciated that the z-axis may be defined at a different angle with respect to the plane of the microelectronic substrate 210 without departing from the scope of the invention.

An additional embodiment depicting an integrated nanostructure array 200′ comprising a microelectronic substrate 210 and a plurality of nanotubes 230 present thereon is illustrated in FIG. 2B. Although similar to the integrated nanostructure array 200 illustrated in FIG. 2A, the catalyst bearing moiety 225 is present as a layer disposed on the surface 215 of the microelectronic substrate 210. In this embodiment, each of the catalyst bearing moieties are activated at a second predetermined set of X and Y coordinates of the microelectronic substrate 210, with the activated portions of the catalyst bearing moieties being denoted as 235. In this embodiment, the width of an activated portion 235 of the catalyst bearing moiety 225 is equal or substantially equal to the width of the nanotube 230 present thereon. The average distances between nanotubes (x₁ and y₁) may be defined as set forth in FIG. 2A. Positioned upon each activated portion 235 of catalyst bearing moiety 225 is a corresponding nanotube 230. The nanotube may have any of the features described hereinabove.

For the purposes of the invention, the integrated nanostructure array encompasses the embodiments described herein for the integrated nanostructure. The array may contain any number of nanostructures; in one embodiment, the array comprises two or more nanostructures. In certain embodiments, one or more of the nanostructures within the array may contain the physical and/or electrical properties set forth herein.

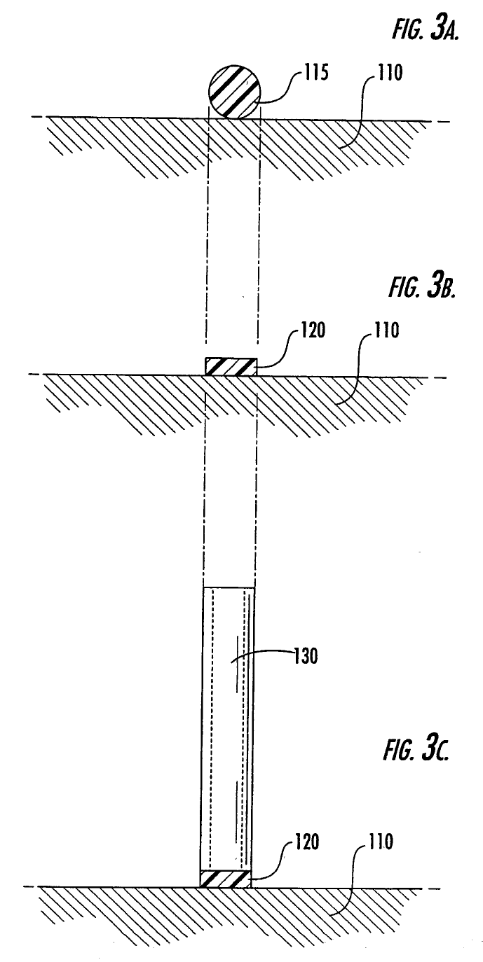

FIGS. 3A through 3B depict a method of selectively forming a nanotube at a predetermined position upon a microelectronic substrate (denoted as 110) in accordance with the present invention. As illustrated in FIG. 3A, a catalyst bearing moiety 125 is deposited upon the microelectronic substrate 110. In this particular embodiment, the catalyst bearing moiety 125 is in the form of a spherically-shaped dendrimer, although other embodiments may be employed such as, without limitation, those described above. Subsequently, the catalyst bearing moiety 125 is activated at the predetermined position according to any suitable technique and thus is transformed into activated catalyst bearing moiety 120. As depicted in this embodiment, the activated catalyst bearing moiety 120 is present as an essentially rectangular structure having a top surface s. Other embodiments and shapes of catalyst bearing moiety 125 and activated catalyst bearing moiety 120 are within the scope of the invention.

Subsequently, as shown in FIG. 3C, a single nanotube 130 is grown upon the activated catalyst bearing moiety 120 according to an accepted technique. The width wₙ of the nanotube 130 is equal or substantially equal to the width wₙ of the corresponding catalyst bearing moiety 120. As shown in FIG. 3C, the single nanotube 130 is grown along an axis (depicted as z) which has a predetermined relationship with respect to a plane defined by the microelectronic substrate 110, i.e., the plane being coincident to the microelectronic substrate surface 115. In this embodiment, the z-axis is essentially perpendicular to the plane defined by the microelectronic substrate 110. It should be appreciated however that the nanotube may be grown according to other orientations with respect to the plane defined by the microelectronic substrate 110.

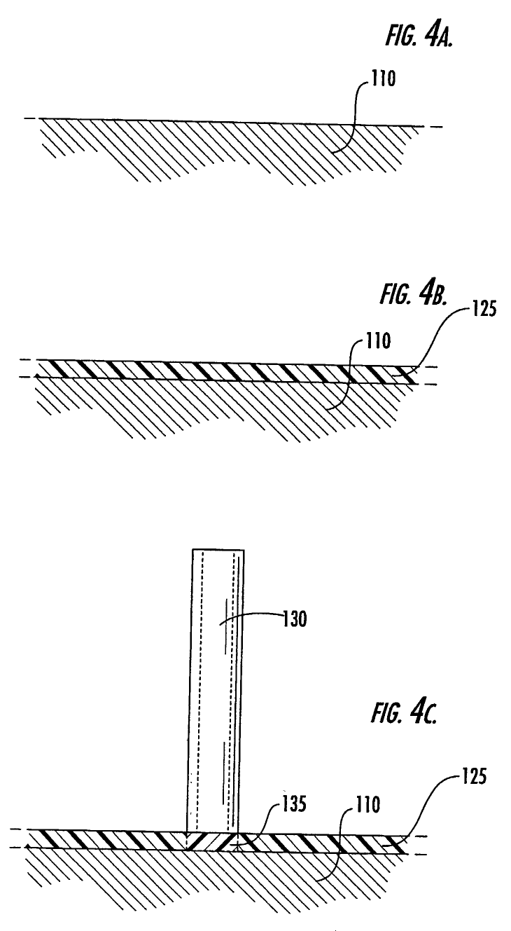

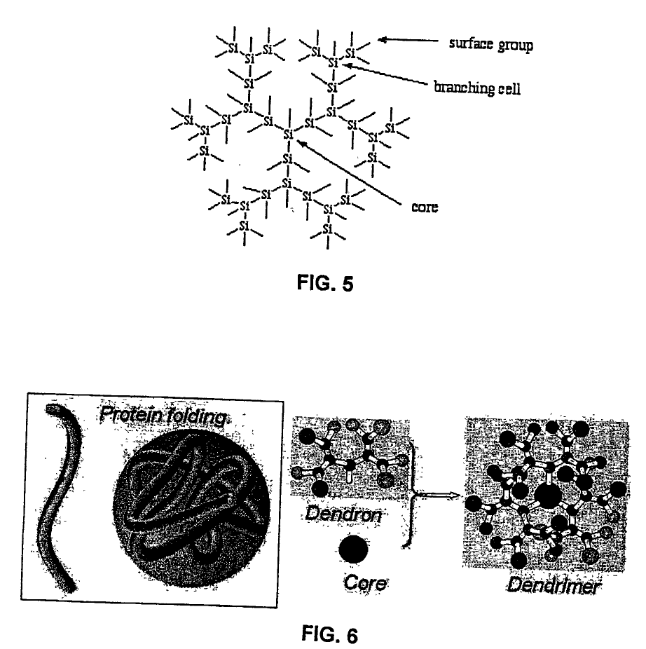

FIGS. 4A through 4C illustrate another method of selectively forming a nanotube at a predetermined position upon a microelectronic substrate in accordance with the invention. A microelectronic substrate 110 is provided as shown in FIG. 4A, and a catalyst bearing moiety 125 is deposited upon the microelectronic substrate 110 as depicted in FIG. 4B. In this particular embodiment, the catalyst bearing moiety 125 is present in the form of a layer 125 present over the surface 115 of the microelectronic substrate 110. Referring to FIG. 4C, a predetermined portion of the catalyst bearing moiety (depicted as 135) is activated and a single nanotube 130 is grown along an axis (i.e., the z-axis) having a predetermined relationship with respect to a plane defined by the microelectronic substrate 110 at a predetermined position of the substrate 110. The width wₙ of the nanotube 130 is equal or substantially equal to the width w_{c} of the corresponding activated portion 135 of the catalyst bearing moiety 125. In the embodiment illustrated in FIG. 4C, the relationship of the z-axis to the plane defined by the microelectronic substrate is similar to FIG. 3C. It should be appreciated however that the nanotube may be grown in other orientations with respect to the plane defined by the microelectronic substrate 110.

The invention will now be described with respect to the following examples. It should be emphasized that these examples are for the purposes of illustrating the invention, and are not to be construed as limiting the invention.

### EXAMPLE 1

### STM Atomic Placement

### Field Assisted Diffusion

An atom used to grow a nanotube is deposited on substrate using an STM field assisted diffusion process. The atom is present on a probe tip, and a tunneling gap spacing of 5 Å and a potential difference of from 1 V to 10 V is employed. As a result, the electric field strength ranges from 0.2 to 2 V Å⁻¹. Larger electric fields can also be employed such as, without limitation, those ranging in strength from 3 to 5 V Å⁻¹. A probe tip having a 100 Å positioned 5 Å above the substrate surface is used to diffuse an atom positioned thereon to the substrate surface.

### EXAMPLE 2

### STM Atomic Placement

### Transfer-On-Contact Process

An atom is transferred to the surface of a substrate by employing a transfer-on-contact process. A voltage barrier of −0.75 eV is employed between the probe tip upon which the atom is present and the substrate surface. The frequency factor is approximately equal to 10¹³ s⁻¹ and a temperature of 300 K is employed. The atom transfer rate to the substrate surface under these conditions is 1 s⁻¹.

### Example 3

### STM Atomic Placement

### Field Evaporation

An atom or mounds of atoms are transferred from a probe tip to a surface by a field evaporation technique utilizing a voltage pulse. As an illustration, a 600 ns pulse of +3.6 V applied to a substrate surface in an STM with an Au probe tip operated in air at room temperature results in the formation of mounds of atoms.

### Example 4

### STM Atomic Placement

An atom is positioned on a probe tip and is deposited on a substrate surface according to the following procedure. A tunnel current ranging from 1×10⁻⁸ A to 6×10⁻⁸ A is present between surface and tip. The tip is then moved under closed-loop conditions across the surface of the substrate at a speed of 4 Å/se to the desired destination on the surface for placement of the atom. The tip is withdrawn by reducing the tunnel current to a value used for imaging. This reduction effectively terminates the attraction between the atom and the probe tip, leaving the atom bound to the substrate surface at the desired location.

### Examples 5-8

### Activation and Nanotube Growth

The atom(s) positioned on the substrates set forth in Examples 1-4 are activated and nanotubes are grown therefrom by employing a Chemical Vapor Deposition (CVD) technique.

The invention has been described in reference to the embodiments set forth above. It should be understood that such embodiments are provided for illustrative purposes-only, and do not limit the scope of the invention as defined by the claims that follow.

That which is claimed:

1. An integrated nanostructure comprising:
a microelectronic substrate having a surface;
a catalyst disposed upon the surface of said microelectronic substrate and positioned thereupon within a first predetermined set of X and Y coordinates, wherein said catalyst is activated within a second predetermined set of X and Y coordinates defined within the surface of said microelectronic substrate; and
a nanotube selectively disposed upon the activated second predetermined set of X and Y coordinates defined within the surface of said microelectronic substrate, such that said nanotube is controllably grown at a predetermined position upon the surface of said microelectronic substrate;
wherein at least one selected from the group consisting of: (1) the disposition according to the first predetermined set of X and Y coordinates and (2) the activation of the catalyst according to the second predetermined set of X and Y coordinates is scaled with atomic precision.

2. An integrated nanostructure according to claim 1, wherein said nanotube is selected from the group consisting of a single-walled nanotube and a multi-walled nanotube.

3. An integrated nanostructure according to claim 1, wherein said nanotube has a helicity defined according to at least one selected from the group consisting of the first predetermined set of X and Y coordinates and the second predetermined set of X and Y coordinates.

4. An integrated nanostructure according to claim 1, wherein said nanotube has an electrical conductivity selected from the group consisting of metallic electrical conductivity, semiconducting electrical conductivity, and insulating electrical conductivity.

5. An integrated nanostructure according to claim 1, wherein said nanotube comprises a tip member selected from the group consisting of a probe tip member, a patterning tip member, and a repair tip member.

6. An integrated nanostructure according to claim 1, wherein the surface of said microelectronic substrate is substantially planar in topography.

7. An integrated nanostructure according to claim 1, wherein the surface of said microelectronic substrate is substantially non-planar in topography.

8. An integrated nanostructure according to claim 1, wherein said microelectronic substrate comprises a plurality of distinct substrates, at least one of said plurality of distinct substrates having said nanotube disposed thereupon.

9. An integrated nanostructure according to claim 8, wherein at least two of said plurality of distinct substrates have said nanotube disposed at a predetermined position thereupon.

10. An integrated nanostructure according to claim 1, wherein said nanotube is defined along an axis that intersects the surface of said microelectronic substrate.

11. An integrated nanostructure according to claim 1, wherein said nanotube is defined along an axis having a predetermined positional alignment with respect to the surface of said microelectronic substrate.

12. An integrated nanostructure according to claim 1, wherein said catalyst is present in the form of at least one catalyst atom.

13. An integrated nanostructure according to claim 1, wherein said catalyst is disposed upon the surface of said microelectronic substrate by a catalyst bearing moiety.

14. An integrated nanostructure according to claim 13, wherein the catalyst bearing moiety is selected from the group consisting of inorganic materials, organometallic materials, dendrimers, biomolecules, and combinations thereof.

15. An integrated nanostructure according to claim 14, wherein said catalyst bearing moiety is at least one dendrimer having a diameter of at least one nanometer.

16. An integrated nanostructure according to claim 14, wherein said catalyst bearing moiety is at least one biomolecule that is selected from the group consisting of RNA, DNA, proteins, and combinations thereof.

17. An integrated nanostructure according to claim 14 wherein said catalyst bearing moiety comprises at least one molecule that is selected from the group consisting of organmetallic molecules, coordinated complexes with catalyst atoms at well defined specific molecular locations, and combinations thereof.

18. An integrated nanostructure according to claim 1, wherein the atomic scale precision is no greater than about 5 angstroms (Å).

19. An integrated nanostructure according to claim 1, wherein the surface of the microelectronic substrate is of uniform integrity.

20. An integrated nanostructure according to claim 1, wherein said least one selected from the group consisting of the disposition according to the first predetermined set of X and Y coordinates and the activation of the catalyst according to the second predetermined set of X and Y coordinates is carried out through integrated circuit vapor deposition processing.

21. An integrated nanostructure according to claim 1, wherein said nanotube is present as a single nanotube.

22. An integrated nanostructure according to claim 1, wherein the disposition of the catalyst is scaled with atomic precision.

23. An integrated nanostructure according to claim 1, wherein the activation of the catalyst is scaled with atomic precision.

24. An integrated nanostructure array, comprising:
a microelectronic substrate having a surface; and
a plurality of nanostructures, wherein each nanostructure within the plurality is disposed in a predetermined positional relationship with respect to the remaining nanostructures within the plurality, each nanostructure comprising:
a microelectronic substrate having a surface;
a catalyst disposed upon the surface of said microelectronic substrate and positioned thereupon within a first predetermined set of X and Y coordinates, wherein said catalyst is activated within a second predetermined set of X and Y coordinates defined within the surface of said microelectronic substrate; and
a nanotube selectively disposed upon the activated second predetermined set of X and Y coordinates defined within the surface of said microelectronic substrate, such that said nanotube is controllably grown at a predetermined position upon the surface of said microelectronic substrate;
wherein at least one selected from the group consisting of: (1) the disposition according to the first predetermined set of X and Y coordinates and (2) the activation of the catalyst according to the second predetermined set of X and Y coordinates is scaled with atomic precision.

25. An integrated nanostructure array according to claim 23, wherein said plurality of nanostructures comprises two or more nanostructures selected from the group consisting of a nanotube probe tip member, a nanotube patterning tip member, and a nanotube repair tip member.

26. An integrated nanostructure array according to claim 23, wherein each nanotube within the plurality comprises a nanotube selected from the group consisting of a single-walled nanotube and a multi-walled nanotube.

27. An integrated nanostructure array according to claim 23, wherein each nanotube within the plurality has a helicity defined according to at least one selected from the group consisting of the first predetermined set of X and Y coordinates and the second predetermined set of X and Y coordinates.

28. An integrated nanostructure array according to claim 23, wherein each nanotube within the plurality has an electrical conductivity selected from the group consisting of metallic electrical conductivity, semiconducting electrical conductivity, and insulating electrical conductivity.

29. An integrated nanostructure array according to claim 23, wherein one or more nanotubes within the plurality operate as an electrical interconnect member having a predetermined electrical conductivity.

30. An integrated nanostructure array according to claim 23, wherein one or more nanotubes within the plurality operate as a mechanical stress relief member.

31. An integrated nanostructure array according to claim 23, wherein one or more nanotubes within the plurality operate as a thermal stress relief member.

32. An integrated nanostructure array according to claim 23, wherein each nanotube within the plurality is defined along an axis having a predetermined positional alignment with respect to the surface of said microelectronic substrate.

33. An integrated nanostructure array according to claim 23, wherein said catalyst is present in the form of at least one catalyst atom.

34. An integrated nanostructure array according to claim 23, wherein said catalyst is disposed upon the surface of said microelectronic substrate by a catalyst bearing moiety.

35. An integrated nanostructure array according to claim 33, wherein said catalyst bearing moiety is selected from the group consisting of inorganic materials, organometallic materials, dendrimers, biomolecules, and combinations thereof.

36. An integrated nanostructure array according to claim 34, wherein said catalyst bearing moiety is at least one dendrimer having a diameter of at least one nanometer.

37. An integrated nanostructure array according to claim 34, wherein said catalyst bearing moiety is at least one biomolecule that is selected from the group RNA, DNA, proteins, and combinations thereof.

38. An integrated nanostructure array according to claim 23, wherein the atomic scale precision is no greater than about 5 angstroms (Å).

39. An integrated nanostructure array according to claim 23, wherein the surface of the microelectronic substrate is of uniform integrity.

40. An integrated nanostructure array according to claim 23, wherein said least one selected from the group consisting of the disposition according to the first predetermined set of X and Y coordinates and the activation of the catalyst according to the second predetermined set of X and Y coordinates is carried out through integrated circuit vapor deposition processing.

41. An integrated nanostructure array according to claim 23, wherein said nanotube is present as a single nanotube.

42. An integrated nanostructure according to claim 23, wherein the disposition of the catalyst is scaled with atomic precision.

43. An integrated nanostructure according to claim 23, wherein the activation of the catalyst is scaled with atomic precision.

44. An integrated nanostructure array according to claim 23, wherein said microelectronic substrate comprises a plurality of distinct substrates, wherein each distinct substrate of said plurality has one or more of said nanostructures disposed thereupon.

45. An integrated nanostructure array according to claim 23, wherein the surface of said microelectronic substrate is substantially planar in topography.

46. An integrated nanostructure according to claim 23, wherein the surface of said microelectronic substrate is substantially non-planar in topography.

47. A method of selectively forming a nanotube at a predetermined position upon a microelectronic substrate, comprising the steps of:
depositing a catalyst bearing moiety upon said microelectronic substrate within a first predetermined set of X and Y coordinates defined within the surface said substrate;
activating the catalyst bearing moiety at a second predetermined set of X and Y coordinates defined within the surface of said microelectronic substrate; and
growing a single nanotube at the second predetermined set of X and Y coordinates along an axis having a predetermined relationship with respect to a plane defined by the microelectronic substrate;
wherein at least one of said steps selected from the group consisting of: (1) depositing a catalyst upon the microelectronic substrate and (2) activating the catalyst is carried out with atomic scale precision.

48. A method of selectively forming a nanotube according to claim 46, wherein the catalyst bearing moiety is selected from the group consisting of inorganic molecules, organometallic materials, dendrimers, biomolecules, and combinations thereof.

49. A method of selectively forming a nanotube according to claim 47, wherein the catalyst bearing moiety is at least one dendrimer having a diameter of at least one nanometer.

50. A method of selectively forming a nanotube according to claim 47, wherein the catalyst bearing moiety is at least one biomolecule selected from the group consisting of RNA, DNA, proteins, and combinations thereof.

51. A method of selectively forming a nanotube according to claim 46, wherein the step of activating the catalyst comprises manipulating the catalyst bearing moiety.

52. A method of selectively forming a nanotube according to claim 46, wherein the step of activating the catalyst comprises inducing a change in the catalyst bearing moiety.

53. A method of selectively forming a nanotube according to claim 46, wherein the step of activating the catalyst comprises patterning the catalyst bearing moiety.

54. A method of selectively forming a nanotube according to claim 52, wherein the step of activating the catalyst comprises patterning the catalyst bearing moiety through AFM.

55. A method of selectively forming a nanotube according to claim 52, wherein the step of activating the catalyst comprises patterning the catalyst bearing moiety through STM.

56. A method of selectively forming a nanotube according to claim 46, wherein the atomic scale precision is no greater than 5 angstoms (Å).

57. A method of selectively forming a nanotube according to claim 46, wherein the surface of the microelectronic substrate is of uniform integrity.

58. A method of selectively forming a nanotube according to claim 46, wherein at least one of step of depositing a catalyst upon the microelectronic substrate or said step of activating the catalyst is carried out through chemical vapor deposition.
